(19) United States
(12) Patent Application Publication
(10) Pub. No.: US 2002/0129157 A1
(43) Pub. Date: Sep. 12, 2002

(54) Method and apparatus for automated service level agreements

(76) Inventor: Shlomo Varsano, Los Angles, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/035,806

(22) Filed: Nov. 8, 2001

Related U.S. Application Data
(60) Provisional application No. 60/246,788, filed on Nov. 8, 2000.

(51) Int. Cl. G06F 15/16; G06F 15/173

(52) U.S. Cl. 709/232; 709/224

(57) ABSTRACT

A method and apparatus for automated generation of a service level agreement delay value and monitoring of a network. Service level agreement delay values are generated by calculating a path delay and standard deviation for a path through the network. A confidence interval is determined for the path delay using the standard deviation. The service level agreement delay value is generated from the path delay and the confidence interval. The network is subsequently monitored in order to predict and track violations of the service level agreement delay value. The subsequent monitoring of the network is performed for both trunks and paths within the network.

### CROSS-REFERENCE TO RELATED APPLICATION

This application claims the benefit of U.S. Provisional Application No. 60/246,788 filed on Nov. 8, 2000, which is hereby incorporated by reference as if set forth in full herein.

### BACKGROUND OF THE INVENTION

Communications and data Network Service providers (NSPs) are system integrators who provide their customers both network components and the expertise to integrate these network components into a complete network solution. In many cases, a NSP offers to provide a network to a customer wherein the network must meet customer specified performance criteria. The obligations of the NSP to meet the customer specified performance criteria are included in a Service Level Agreement (SLA).

NSPs compete with each other for customers by offering network solutions that meet a customer's specifications at the lowest possible cost. A SLA usually contains a minimum level of performance as measured against customer specified performance criteria for a given network. A NSP usually accepts the risk of the network falling below the minimum level of performance. A NSP therefore attempts to propose a network that will operate above the minimum level of performance specified in the SLA without designing a network that is too expensive to be acceptable to the customer.

A SLA is a form of traffic contract that guarantees a particular level of service for a given price. The primary difference between a SLA and a normal ATM traffic contract is that a SLA has a tariff that stipulates the NSP is able to test and verify that the NSP is delivering contracted levels of service. Any number of Quality of Service (QoS) parameters can be contained in the SLA, including terms for supporting multiple classes of service.

At present, a NSPs Service Level Agreement SLA delays typically are estimated by a adding a constant delay margin (fixed value, e.g., 20 msec. or a proportional margin, e.g., 20% of round trip delay) to measured PING samples. This practice exposes NSPs to two risks: if actual performance were poorer than SLA estimates then the NSP may be vulnerable to SLA violations; and if actual performance is better than the SLA estimates, then the published SLA performance may not be competitive.

In order to support a NSP's SLA verification for network services, the NSP should develop a scientific and methodical approach for managing a network. A management system should also allow the simultaneous verification of SLAs for multiple classes of service over the entire network. Once a network is in place, a NSP may retain operational control of the network to the extent necessary to monitor the performance of the network. The NSP would like to know if the performance of the network is such that the network may fall below the minimum level of performance as specified in the SLA before the network actually does so. Furthermore, in both the design and operation of a network, a NSP needs a way to accurately predict the performance of a network without actually inducing a controlled or experiencing an uncontrolled network failure. The present invention meets such need.

### SUMMARY OF THE INVENTION

In one aspect of the invention, a method is provided for generating a service level agreement delay value for a network. A set of network delay samples is taken from a network. A path delay is generated for a path through the network using a specified time period and the set of network delay samples. A confidence interval, for example the sample error, for the path delay is generated using the path delay, the specified time period, the set of network delay samples, and a confidence level. The service level agreement delay value is generated by adding the path delay and the confidence interval.

In another aspect of the invention, the set of network delay samples is filtered using a data sieve to remove superfluous paths that result during a primary-path failure.

In another aspect of the invention, the specified time period is a path busy period for the path.

In another aspect of the invention, generation of a path busy period includes receiving a time period; generating a first path delay over the time period at a first time point using the set of network delay samples; generating a second path delay over the time period at a second time point using the set of network delay samples; and generating the path busy period by comparing the first path delay to the second path delay, or rolling average delay. The time period with the highest path delay is chosen as the path busy period.

In another aspect of the invention, path delays are generated by determining a set of trunks included in the path. Then for each trunk in the set of trunks, performing the following steps: generate a trunk delay over the time period at the time point using the set of network delay samples; and add the trunk delay to the path delay. The path delay is thus the sum of the trunk delays included in the path.

In another aspect of the invention a confidence interval for the path delay is generated in the following manner. A set of trunks included in the path is determined. A set of trunk delay standard deviations is generated for the set of trunks for the path busy period using the set of network delay samples. A path delay standard deviation is generated using the set of trunk delay standard deviations by taking the Root Mean Squared (RMS) value of the trunk standard deviations. The confidence interval is then generated using the path delay standard deviation and the confidence level.

In another aspect of the invention, a method for monitoring a network is provided. The method includes collecting a set of network delay samples from the network. A path busy period is determined for a path through the network using the set of network delay samples. A path delay for the path is generated using the path busy period and the set of network delay samples. In addition, a path delay standard deviation is generated using the path delay, path busy period, and the set of network delay samples. A coefficient of variation is generated for the path using the path delay and the path standard deviation. This coefficient of variation is compared to threshold values in order to generate alarms.

In another aspect of the invention, a data processing apparatus is adapted for monitoring a network. The data processing apparatus includes a processor and a memory operably coupled to the processor. Program instructions are stored in the memory with the processor being operable to execute the program instructions. In accordance with the instructions, the data processing system receives a set of network delay samples. The data processing apparatus then determines a trunk busy period for a trunk included in the network using the set of network delay samples. The data processing apparatus generates a confidence interval for the trunk using the trunk busy period, the set of network delay samples, and a confidence level. The data processing system generates a busy period trunk delay for the trunk using the trunk busy period, the set of network delay samples, and the confidence interval. The data processing apparatus compares the busy period trunk delay to a busy period trunk delay baseline including a plurality of previously generated busy period trunk delays to determine if the network is operating properly.

In another aspect of the invention, a data processing apparatus adapted to monitor a network generates a trunk busy period in the following manner. The data processing apparatus receives a time period and generates a first trunk delay over the time period at a first time point using the set of network delay samples. The data processing apparatus generates a second trunk delay over the time period at a second time point using the set of network delay samples. The data processing apparatus generates the trunk busy period by comparing the first trunk delay to the second trunk delay.

### BRIEF DESCRIPTION OF THE DRAWINGS

These and other features, aspects, and advantages of the present invention will become better understood with regard to the following description and accompanying drawings where:

FIG. 1 is a diagram of an embodiment of a network performance monitor in accordance with the present invention;

FIG. 2 is a block diagram of an exemplary automated service level agreement delay generator in accordance with the present invention;

FIG. 3 is a network diagram depicting a path with multiple trunks through an exemplary network;

FIG. 4 is a process flow diagram of a statistical analysis process for an automated service level agreement delay generator in accordance with the present invention;

FIG. 5 depicts an exemplary set of delay data for a single trunk's delays;

FIG. 6 is a pseudocode listing describing an exemplary busy period determination process in accordance with the present invention;

FIG. 7 depicts pseudocode for a standard deviation generation process for trunks within a path in accordance with the present invention;

FIG. 8 is an illustration of the relationship between a path delay, a confidence interval, and a SLA delay for a network wherein observed traffic delays can be described by a Gaussian distribution;

FIG. 9 is a block diagram of an exemplary process for generating a trunk SLA delay value for a new trunk in accordance with the present invention;

FIG. 10 is a process flow diagram for an exemplary system for a network delay performance system in accordance with the present invention;

FIG. 11 is a block diagram of an exemplary coefficient of variation alert generator in accordance with the present invention;

FIG. 12 is a hardware architecture diagram of a general purpose computer suitable for generation of SLA delays or use as a host for a network delay performance system in accordance with the present invention; and

APPENDIX A is a pseudocode listing for exemplary network data analysis processes in accordance with the present invention.

### DETAILED DESCRIPTION

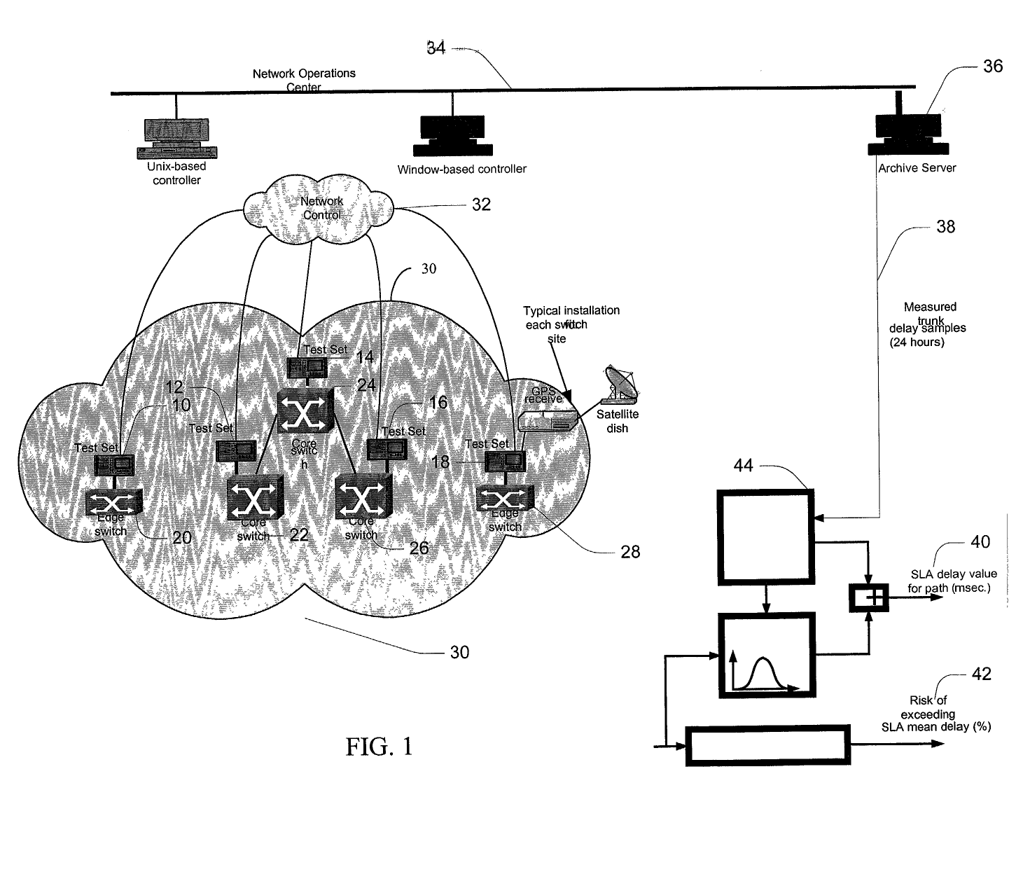

FIG. 1 is a diagram of an embodiment of a network performance monitor in accordance with the present invention. Remote distributed testing (RDT) test systems 10, 12, 14, 16, and 18 are used to monitor a network 30. A plurality of test systems are installed at switching centers 20, 22, 24, 26, and 28 within the network. The test systems are controlled from one or more remote control centers 32. The multiple test systems can be combined logically to operate as a single unit, regardless of the geographic distances between them. The resulting virtual test system allows test engineers to perform multipoint network tests. Test traffic is generated and routed on demand between any two switching centers within in the network. The virtual test system allows all personnel who monitor the network performance to be located at a Network Operations Center (NOC) 34. The distributed test system is programmed to generate test traffic to determine if an individual switching center's policing mechanism is handling excess traffic correctly. This includes determining if nonconforming data packets are discarded or tagged when the traffic contract is violated and if conforming traffic is allowed to pass freely through the switching center. Network probes (not shown) hosted by the test systems combine the functionality of a protocol analyzer and transmission monitor. The network probes generate large volumes of data that can easily exceed the memory capacity of a network probe. Therefore, a centralized database 36 is used to collect and aggregate data from all the network probes. The aggregate data includes delay data collected for transmission delays experienced by test traffic routed through the network.

A generation of a minimum performance level for the network is accomplished by reading the delay data 38 collected from the network probes and performing a statistical analysis of the delay data in an automated SLA generation process 44. A minimum performance level in the form of an estimated delay 40 for a data packet transmitted through the network is generated along with an assessment of the risk 42 of exceeding the estimated delay by the automated SLA delay generator.

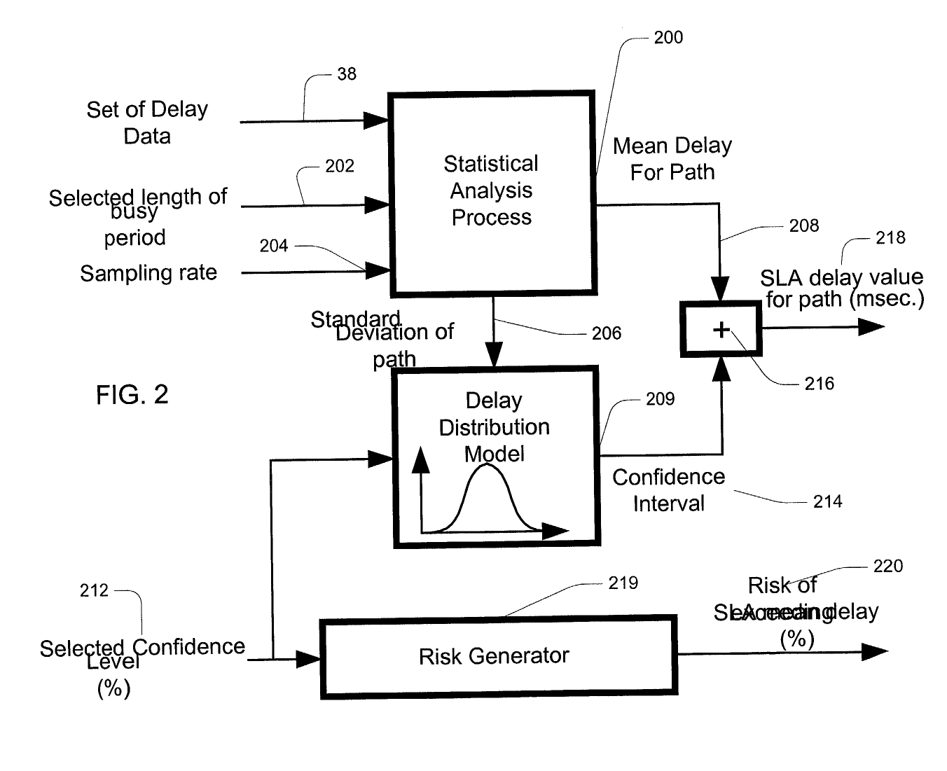

FIG. 2 is a block diagram of an exemplary automated service level agreement delay generator in accordance with the present invention. The automated SLA delay generator includes a statistical analysis process 200. The statistical analysis process receives a set of network delay data 38 for a network. The statistical analysis process also receives a selected length of a busy period 202 and a data sample rate 204. The statistical analysis process uses the set of delay data, selected length of busy period, and sample rate to generate a delay standard deviation 204 and a path delay 208 for a path through the network.

The automated SLA delay generator further includes a a distribution model 209 describing the statistical distribution of the delay data that includes a sample error generator. The automated SLA delay generator receives a selected confidence level 212 and uses the selected confidence level, the standard deviation of path delay, and the distribution model to generate a confidence interval 214, such as a sample error. The sample error is added 216 to the sample mean of the path delay to generate a SLA delay for the path 218. The automated SLA delay generator further includes a risk generator 219 to generate a risk of exceeding the SLA delay for the path 220 using the selected confidence level.

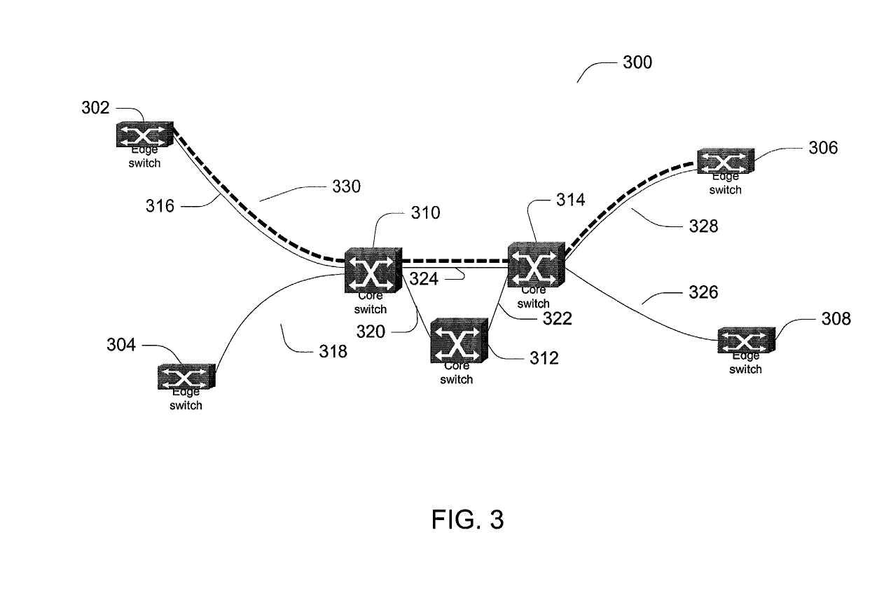

FIG. 3 is a network diagram depicting a path with multiple trunks through an exemplary network. The network includes a plurality of edge switches 302, 304, 306, and 308. The network further includes a plurality of core switches 310, 312, and 314. The switches are connected to each other via trunks 316, 318, 320, 322, 324, 326, and 328. While the exemplary path is shown with multiple trunks, a may include only one trunk. An exemplary path 330 through the network passes between edge switch 302 and edge switch 306 via trunk 316 to core switch 310 via trunk 324 to core switch 314 and via trunk 328 to edge switch 306. Therefore, to determine a SLA delay for the path, aggregate data including delay samples is collected and analyzed for each of the trunks included in the path.

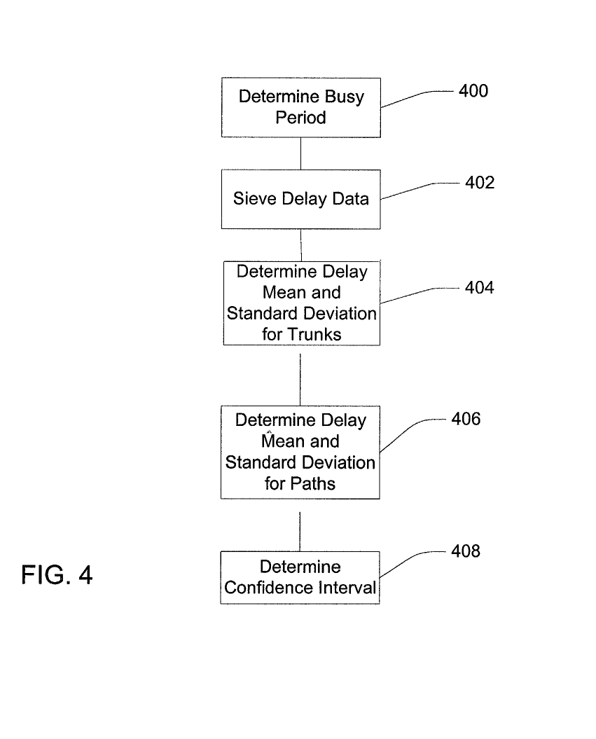

FIG. 4 is a process flow diagram of a statistical analysis process for an automated SLA delay generator in accordance with the present invention. The statistical analysis process determines 400 a busy period of a path using a set of delay data in a to be described process. The statistical analysis process sieves 402 the set of aggregate data in a to be described process to remove unneeded trunks from the path. The data analysis process determines 404 the standard deviation and mean of the delay of each trunk in the path using the sieved set of aggregate data in a to be described process. Finally, the data process determines 406 the standard deviation and mean of the delay of a path in a to be described process.

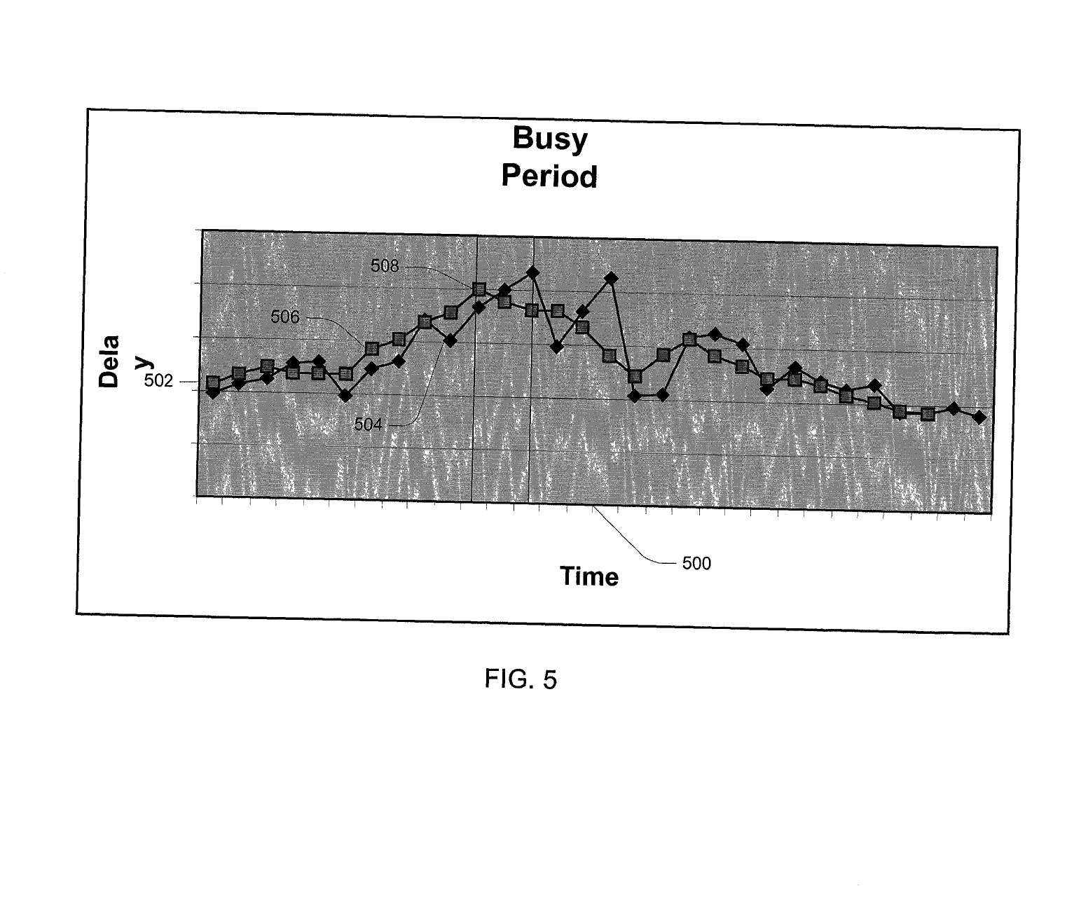

FIG. 5 depicts an exemplary set of delay data for a single trunk's delays. Delays 504 are plotted along the Y axis 502 as determined for each time period plotted along the X axis 500. A busy period is a specific time period during which the trunk's delays are the highest as averaged over the time period. For example, the time period, or window, over which the delays are averaged is three units of time. The average value of the delays 506 is plotted at the ordinal value of the first unit of time included in the window. For the exemplary data set, the highest average delay time for a window of time is at average delay value 508. This indicates that the busy period for the exemplary data is in the window 510.

The relationship of delay samples for an entire network including a plurality of switches and trunks or hops can be described by a 3-dimensional matrix of the order m*n*p that includes scalar components. For the remainder of this discussion, an exemplary 3-dimensional matrix representation of the sample data will be used in descriptions of exemplary processes. In the exemplary 3-dimensional matrix, each element of the 3-dimensional matrix, Aᵢⱼₖ is a delay sample in milliseconds where:

i=path number, with 1≦i≦m

j=hop number with 1≦j≦n

k=ordinal number of timestamp 1≦k≦p

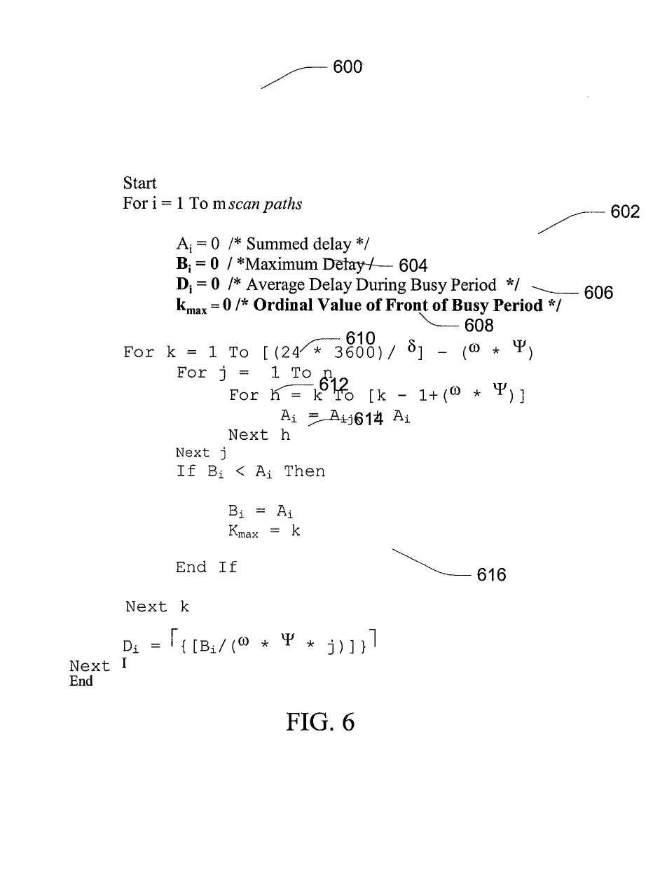

FIG. 6 is a pseudocode listing describing an exemplary busy period determination process in accordance with the present invention, where:

δ=Sampling interval in seconds, with 300 seconds≦δ≦600 seconds

ω=Number of samples per hour with ω=f(δ)=(3600)/δ

Ψ=period of averaging delay, with 1≦Ψ≦24

Aᵢ=Intermediate aggregated delay

Bᵢ=Intermediate maximum aggregated delay

Dᵢ=Average delay for path i

Kₘₐₓ=First ordinal number of timestamp of busiest hour(s) period in a 24-hour period. This value is used for computing the path-dependent standard deviation for trunks and the 95 percentile delay.

As previously described, the delay samples are stored as a 3-dimensional matrix. This matrix is scanned to determine a busy period for each path. For each path 600 in the matrix, a busy period of length Ψ is determined by summing the delays in a moving time period or window of size ω*Ψ, at steps 602, 604, 606 and 608. If the sum of delays for the moving window is the greatest sum of delays seen so far, the sum of the delays is saved as the maximum summed delay 612, and the ordinal of the timestamp or time point is saved as the first ordinal of the busy period window 614. After the busy period is determined, an average delay for the busy period for the path is calculated at step 616.

When Ψ is chosen such that it is less than 24 hours, the average delay is interpreted as the busy-hour delay. For example, if Ψ=1 hour, Dᵢ yields the average delay of busiest one hour in a 24-hour period; if Ψ=2 hours then Dᵢ yields the average delay of the 2 busiest-consecutive-hours in a 24-hour period; if Ψ=23 hours Dᵢ yields the average delay of the 23 busiest-consecutive-hours in a 24-hour period; and when Ψ=24 hours] Dᵢ yields the average 24-hour delay in a 24-hour period.

Referring again to FIG. 4, a statistical analysis process further includes a data sieve process 402 for sieving of undesirable delay paths such as intra-site paths, equal-delay path, and paths that were formed as a consequence of a network failure and produce long delays. An exemplary data sieving process in accordance with the present invention uses a route tree to describe the path. The route tree may be described as a two-dimensional matrix with scalar elements, subscripted with ‘x’ for path number and ‘y’ for hop number such that N_{xy} designates a unique node.

Each trunk within a path operates in full duplex mode and the route tree lists traceroutes in both directions of the path. For example, delay in the direction from N₁₁ to N₁ₚ is designated Bᵢ⁺ and delay in the direction from N₁ₚ to N₁₁ is designated Bᵢ⁻ The following pseudocode describes a data sieving process as used by an exemplary data sieve process in accordance with the present invention:

1. Remove delay values for paths containing two nodes AND these two nodes are located in the same site (e.g., node LAX1 and node LAX2. The result is delays of trunks within a hub are eliminated).

2. Remove delay values for Bᵢ⁺ if Bᵢ⁺≧Bᵢ⁻. For each edge switch pair, one of two paths with the higher delay is eliminated and also the edge switch pair with equal delay is eliminated. Edge switch pairs with higher delays are eliminated to exclude paths that were formed because of a network failure and those with asymmetric routes.

3. Remove delay values for Bᵢ⁻ if Bᵢ⁻≧Bᵢ⁻.

An exemplary statistical analysis process further includes a trunk standard deviation process 404 for generating trunk delays and standard deviations for trunks within paths. The trunk delay standard deviation that is computed for each trunk is path-dependent. The standard deviation for any specific trunk may vary from one path to another because a first ordinal number of timestamp for a busiest period is determined by total path delay, not individual trunk delay. For example, a trunk may carry network traffic for two different paths, path 1 and path 2. Each of the paths may have a terminus in a separate city with each city in a different time zone. In this case, the busy period for path 1 will be different than that for path 2. In this case, the trunk delay is calculated for each of the path's busy periods.

A standard deviation of a mean is given by:

$$σ = {\{ ( 1 / ( n - 1 ) ) [ {\sum }_{i = 1}^{n} {( {x}_{i} - μ )}^{2} ] \}}^{1 / 2}$$

Where:

σ=Standard Deviation (milliseconds)

n=Number of samples

xᵢ=Delay of sample i, (milliseconds)

μ=Average delay (milliseconds)

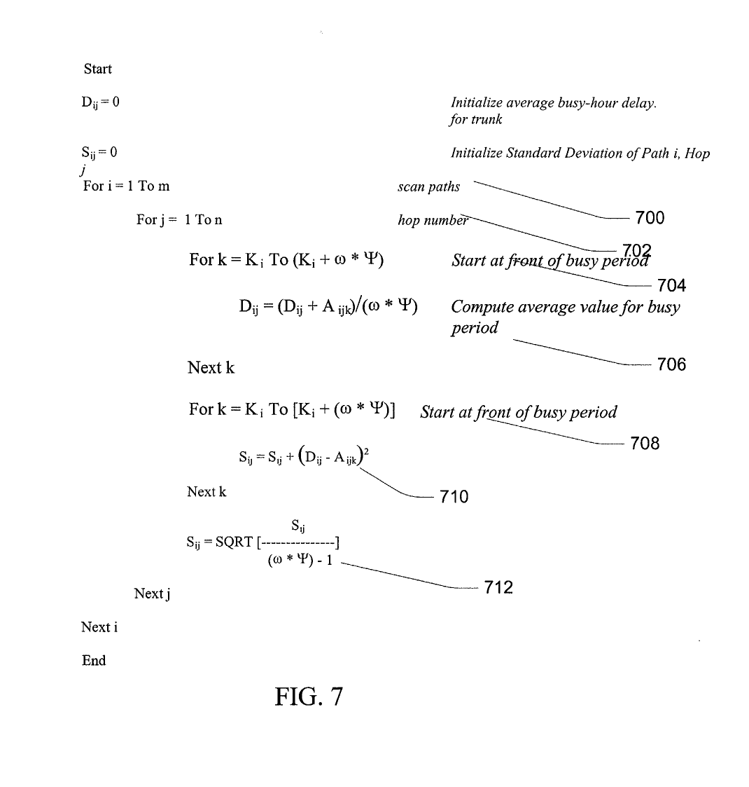

FIG. 7 depicts pseudocode for a standard deviation generation process for trunks within a path in accordance with the present invention. For each path as determined at step 700, and for each hop as determined at step 702, an average delay is calculated for the path's previously described busy period at steps 704 and 706. Once the average delay for the path's busy period is determined, the standard deviation is calculated at steps 510 and 512.

Referring again to FIG. 4, a statistical analysis process in accordance with the present invention further includes a path delay standard deviation process 406 for generating a delay and standard deviation for a path. An exemplary path delay and standard deviation process in accordance with the present invention receives the standard deviations for the trunks within a path. The path delay standard deviation process uses the standard deviations of the trunks within a path to generate a standard deviation for the path. The standard deviation for a path is generated from the individual trunk standard deviations by taking the square root of the sum of the squares:

σₚₐₜₕ={σ_{Trunk1}²+σ_{Trunk2}²+ . . . +σ_{TrunkN}² )}^{½}

Where:

σₚₐₜₕ=Standard Deviation of the path delay, milliseconds

σ_{Trunki}=Standard Deviation of a trunk i, milliseconds

Referring again to FIG. 2, an automated service level agreement delay generator further includes a delay distribution model 209. The delay distribution model includes a statistical function describing the distribution of the delay samples taken from the network. The delay distribution model is used to determine the upper bound of the confidence interval using a selected confidence level 212 and a standard deviation of a path 206. In one embodiment of a delay distribution model in accordance with the present invention, the delays are modeled as having an assumed Gaussian distribution. The confidence interval is calculated by:

$$Confidence Interval = Z * \frac{{σ}_{path}}{{( 3600 / δ )}^{1 / 2}}$$

Where:

Z=Variable of the Error Function, erf Z

erf Z=Error Function

1−α=User input confidence coefficient (=2*erf Z)

σₚₐₜₕ=Standard deviation of delay samples per path

δ=Sampling interval

Z is taken from the following lookup table:

| 1-α | |
|---|---|
| Confidence Level | Z |
| 90% | 1.645 |
| 91% | 1.695 |
| 92% | 1.751 |
| 93% | 1.812 |
| 94% | 1.881 |
| 95% | 1.960 |
| 96% | 2.054 |
| 97% | 2.170 |
| 98% | 2.326 |
| 99% | 2.576 |
| 99.9% | 3.291 |
| 99.99% | 3.891 |

In other embodiments of delay distribution model in accordance with the present invention, the distribution of the delays is modeled using other forms of error functions. In these embodiments, a different lookup table is used to calculate the confidence interval.

Once the path delay 208 and the confidence interval, for example the sample error, have been determined, they are combined 216 to produce a SLA delay 218.

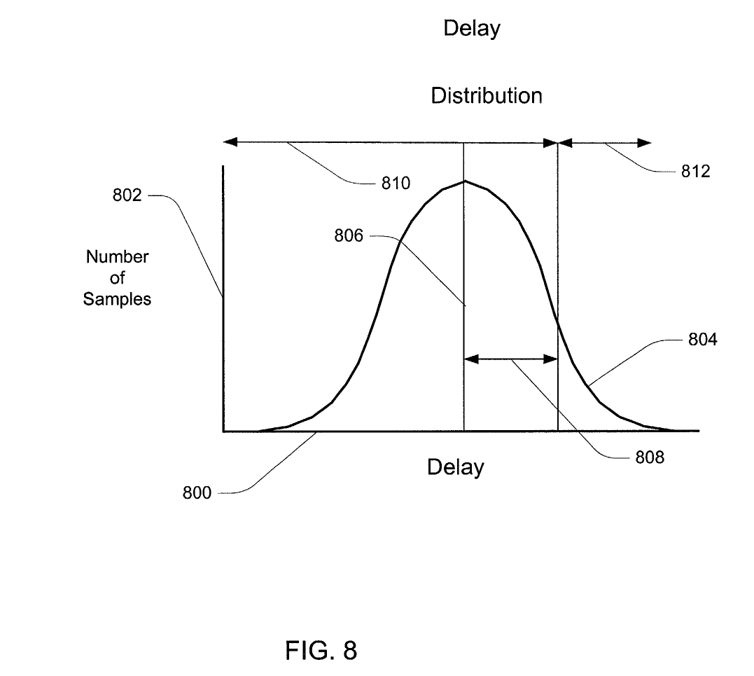

The selected confidence level determines the risk of violating a SLA by having traffic on the network experience delays in excess of the SLA delay. FIG. 8 is an illustration of the relationship between a path delay, a confidence interval, and a SLA delay for a network. Delay values are plotted along the X axis 800 and the number of observed delay samples with a specific delay value are plotted along the Y axis. The distribution of the delay samples is shown as a distribution curve 804. A path delay value 806 is shown at the center of the distribution curve. The magnitude of the confidence interval is shown as an offset 808 from the path delay. Combining the path delay and the confidence interval creates a SLA delay 810. Note that some of the observed delays 812 fall above the SLA delay value. The risk of an observed delay value falling above the SLA delay value is evaluated by (100−Confidence Level)/2.

The SLA delay value is used to write SLAs with a known level of risk. For example, if it is determined that the path delay between city A and city B is 300 mSec with a 30 mSec standard deviation, then the SLA delay time at a 95% confidence level is (300 mSec+1.960*30 mSec) or 358.8 mSec. At a 95% confidence level, 95% of all observed delays will fall within the range of 241.2 mSec to 358.8 mSec with a 2.5% probability of an observed delay falling below 241.2 mSec and a 2.5% probability that an observed delay will fall above 358.8 mSec. This means that 97.5% of all observed delays will be less than or equal to 358.8 mSec. Put another way, the risk of an observed delay exceeding 358.8 mSec is 2.5%.

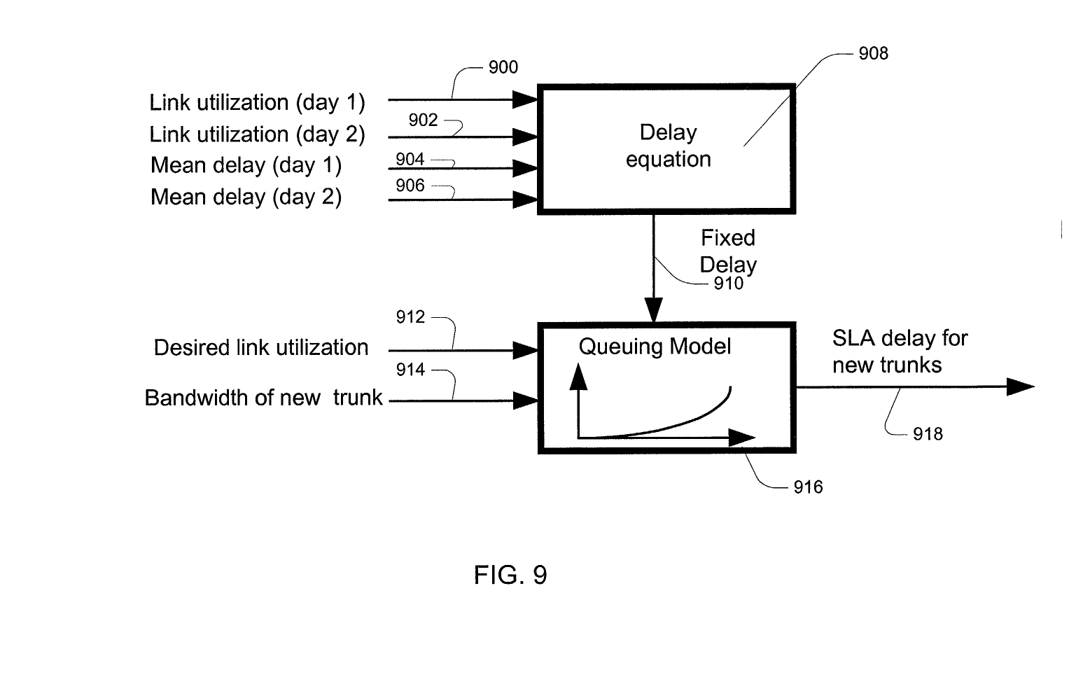

FIG. 9 is a block diagram of an exemplary process for generating a trunk SLA delay value for a new trunk in accordance with the present invention. Because of the typically low utilization of a new trunk, there is a need to simulate delay for that trunk as if it were moderately utilized to avoid an SLA delay value that is too low. This low SLA delay value may result in SLA violations when utilization increases. New trunk SLA delays can be extrapolated from a fixed delay from contiguous trunk delay measurements for a short time T (for example, one hour during very low traffic activity and when delay variation is expected to be relatively low). Link utilization on a first day 900, link utilization on a second day 902, mean delay for the first day 904, and mean delay for the second day 906 are used to generate a fixed delay 910 using a delay equation 908. The delay equation is as follows:

$$Fixed Delay = \frac{1}{2} [ D 1 + D 2 - TS ( \frac{U 1}{1 - U 1} + \frac{U 2}{1 - U 2} ) ]$$

Where:

D1=Average delay for period of time T on day 1

D2=Average delay for period of time T on day 2

U1=Average link utilization for period of time T on day 1

U2=Average link utilization for period of time T on day 2

TS=Serialization delay for link

The fixed delay is used along with a desired link utilization value 912, and a bandwidth value for the new trunk 914, and a queuing model 916 to generate a SLA delay for a new trunk.

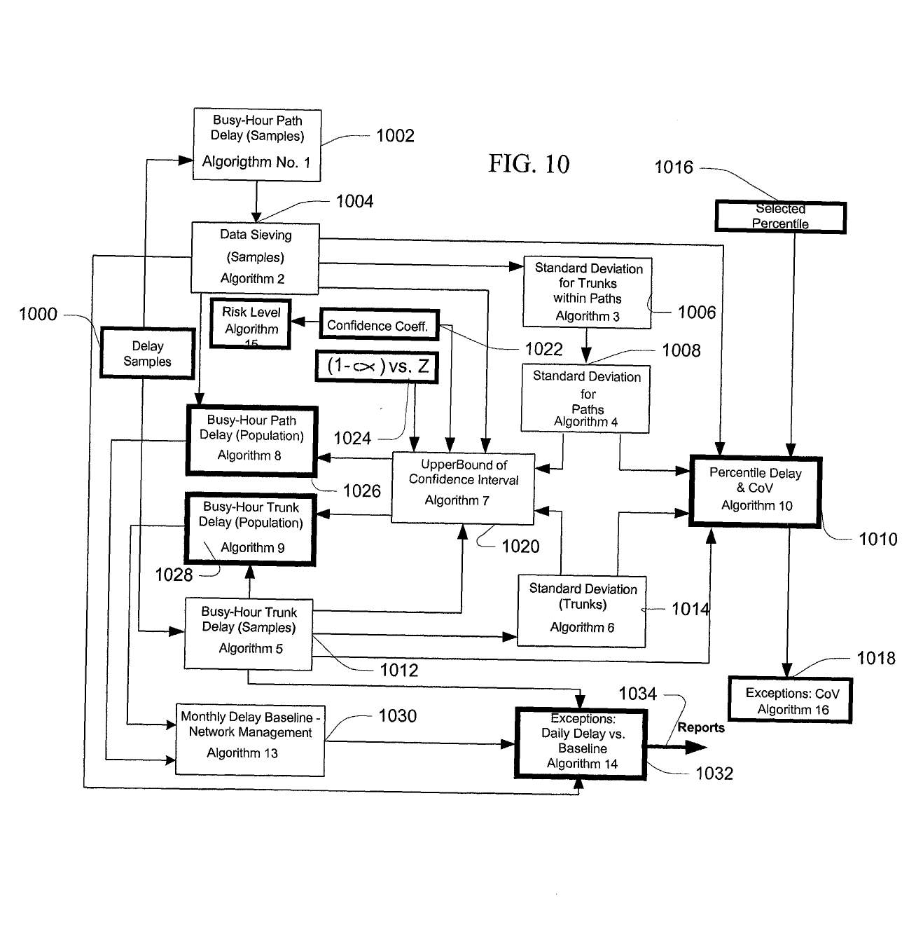

FIG. 10 is a process flow diagram for an exemplary system for a network delay performance system in accordance with the present invention. The network delay performance system is used to monitor the performance of a network. The performance of the network is monitored by generating a baseline of trunk and path delay values that are compared to daily trunk and path delay values. Additionally, a metric comparing the standard deviation of a delay value with the delay to generate a dimensionless measure of network stability is used to detect network delay variability that may indicate network problems. The network delay performance system receives a set of delay samples 1000 from a network. The network delay performance system analyses the set of delay samples in order to monitor the network's performance. The network delay performance system includes a previously described busy period process 1002 for determining a busy period and average delay for the busy period of a path through the network using the set of data delay samples. The network delay performance system further includes a previously described data sieving process 1004 for elimination of unnecessary trunks from the path. The output of the data sieving process is used in a previously described standard deviation for trunks process 1006 to determine the standard deviation of the mean delay of each trunk in the path. The network delay performance system further includes a previously described standard deviation for paths process that uses the trunks' standard deviations to determine the standard deviation of the path.

The network delay performance system also monitors the performance of the network at the trunk level. The set of delay samples is used to generate trunk statistics in much the same way as path statistics are generated. The network delay performance system further includes a busy period and trunk delay process 1012 for detection of a trunk's busy period and calculation of the mean delay for the trunk at the trunk's busy period. The algorithm used is similar to the algorithm used to determine a path's busy period and mean delay and is fully detailed in APPENDIX A. The network delay performance system further includes a standard deviation for trunks process 1014 for the determination of the standard deviation of the mean delay for each trunk during the trunk's busy period. This process is similar to the previously described standard deviation for trunks in a path process 1006 however the trunk's busy period is used rather than a path's busy period. The complete algorithm is presented in APPENDIX A.

A path's and a trunk's mean delays and standard deviations of the mean delays are analyzed by a percentile delay and Coefficient of Variation (CoV) process 1010 for determining the percentile path delay for the nine busiest consecutive delay hours in a 24-hour period and a percentile trunk delay for the nine busiest consecutive delay hours in a 24-hour period for network management. The percentile delay is selected 1016 and used along with a trunk or path mean delay standard deviation to generate a CoV value and percentile delay value. These measures are used to monitor the performance of a network.

For many purposes it is convenient to express the dispersion of results in relative rather than absolute terms. The CoV is defined as the ratio of the standard deviation to the mean and is a dimensionless quantity. Even if utilization is constant and relatively low, e.g., 70% for a T1 link but the CoV of delay is relatively high, percentile delay can be three to five times the value of average delay. For many delay-sensitive customer applications, the application would tear down the connection (time out) if percentile delay exceeds the threshold of the application timer, i.e., keepalive timer, for maintaining the session. The variability of the response time is an important statistic since a highly variant response time may result in unnecessary retransmissions. For example, the measurement and monitoring of the CoV of delay is important for voice over ATM services. Mean delay may be within the acceptable bounds but if the CoV of delay is high, the Mean Opinion Score (MOS) of voice services may be unacceptable. Therefore, CoV is a useful metric for monitoring the performance of trunks under load for delay sensitive applications including voice and video. Video broadcast services can tolerate relatively large delays but delay variation is not tolerable. Average delay is not a good indicator for gauging quality of links for voice over ATM, instead, percentile delay may be monitored. The network delay performance system includes a CoV alert generator 1018 for generation of CoV alerts.

The 95th percentile delay is a well-defined- and widely recognized metric. The 95th percentile is a value that only 5% of delay samples exceed. Also, the value of samples will be less than the 95th percentile 95 percent of the time. Percentile delay serves as the benchmark for the upper bound of delay above which performance of multimedia applications is unacceptable. Therefore, 95th-percentile delay can serves as one of the components for capacity management. Capacity management denotes the problem of ensuring that the currently available network resources are used to provide the highest performance during peak traffic. Peak traffic can be defined as the 95-percentile delay. Also, Some NSPs establish the 95-percentile delay as threshold of sustainable delay for network trunks in order to maximize bandwidth usage.

The 95 percentile delay is produced for the total population of traffic for the nine busiest consecutive hours in a 24-hour period for each trunk and path using a lookup table. The CoV is given by:

$$CoV = \frac{{σ}_{path}}{\begin{matrix}average delay for samples of nine busiest \\ consecutive hours in a 24 \text{-} hour period\end{matrix}}$$

The CoV is then used in a look up table to determine a value to multiply by the path average delay to generate a percentile delay. An exemplary 95th percentile delay look up table is as follows:

| | | | | | |
|---|---|---|---|---|---|
| CoV → | 0.01 | 0.03 | 0.05 | 0.07 | 0.09 |
| Ratio → | 1.015 | 1.045 | 1.08 | 1.115 | 1.15 |
| CoV → | 0.11 | 0.13 | 0.15 | 0.17 | 0.19 |
| Ratio → | 1.185 | 1.22 | 1.255 | 1.295 | 1.33 |
| CoV → | 0.21 | 0.23 | 0.25 | 0.27 | 0.29 |
| Ratio → | 1.365 | 1.405 | 1.44 | 1.48 | 1.515 |
| CoV → | 0.31 | 0.33 | 0.35 | 0.37 | 0.39 |
| Ratio → | 1.555 | 1.595 | 1.635 | 1.675 | 1.715 |

Once the Ratio is determined from the lookup table and the CoV, the 95^{th} percentile is given by: 95^{th} Percentile delay=average delay for samples of nine busiest consecutive hours in a 24-hour period*Ratio].

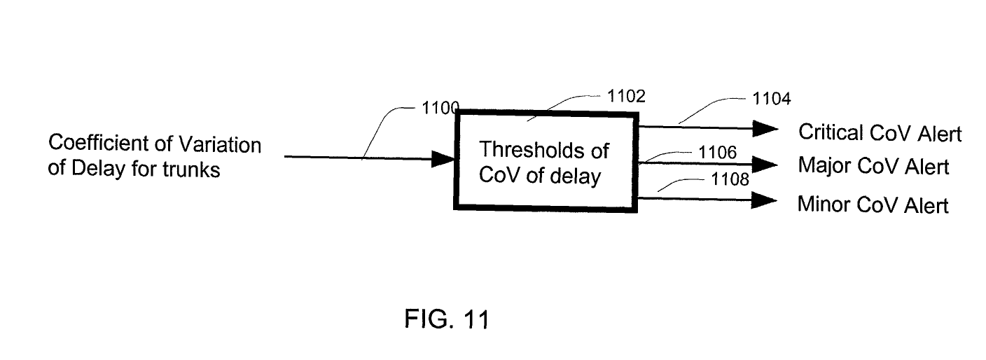

FIG. 11 is a block diagram of an exemplary CoV alert generator in accordance with the present invention. The CoV alert generator 1102 receives a CoV value 1100. The CoV alert generator generates CoV alerts 1104, 1106, and 1108 using the CoV value and a set of selected thresholds. When volatility of delay is low (CoV≦0.1) mean delay that is affected by utilization is the significant indicator of trunk performance. When the CoV is high (CoV>1), percentile delay becomes the significant indicator of trunk performance. In an embodiment of a CoV alert generator in accordance with the present invention, CoV thresholds are set as follows:

| Alert Stage | CoV | Percentile Delay |
|---|---|---|
| Critical | 2.0 | 4.8 × mean delay |
| Major | 1.0 | 3.0 × mean delay |
| Minor | 0.5 | 1.9 × mean delay |

Referring again to FIG. 10, the network delay performance system further includes a previously described upper bound of confidence interval process 1020. The upper bound of confidence interval process generates confidence intervals for both trunks and paths using a path or trunk mean delay and standard deviation, confidence coefficient 1022, and confidence coefficient vs. Z lookup table 1024. The confidence intervals are used in a busy period path delay process 1026 and a busy period trunk delay process 1028 to determine the busy period delays for both paths and trunks. The algorithm for calculating a busy period delay is similar to the previously described SLA delay generation process. The confidence interval of the average delay for a path's or trunk's busy period is added to the average delay for a path's or trunk's busy period. A pseudocode listing is provided for each process in APPENDIX A.

The path and trunk busy period delays are tracked by a monthly delay baseline network management process 1030. The path and trunk busy period delays are stored in a database. Baseline values are generated and reported in order to track the performance of a monitored network over time. The baseline process collects daily average values of busy period delay for one calendar month, computes the 95 percentile of daily delay values, and stores the 95 percentile values. The process is repeated on a monthly basis. A pseudocode listing for this process is included in APPENDIX A.

The network delay performance system further includes a daily delay vs. baseline exceptions reporting process 1032. In this process, daily path and trunk delays are compared to baseline delays to detect critical network performance problems. For each city pair, a daily delay value is compared with a delay value of the delay baseline of the previous month. If the daily delay value exceeds the delay baseline of the previous month by a threshold amount, then a report 1034 is generated detailing the excessive daily delay. A pseudocode listing for this process is included in APPENDIX A.

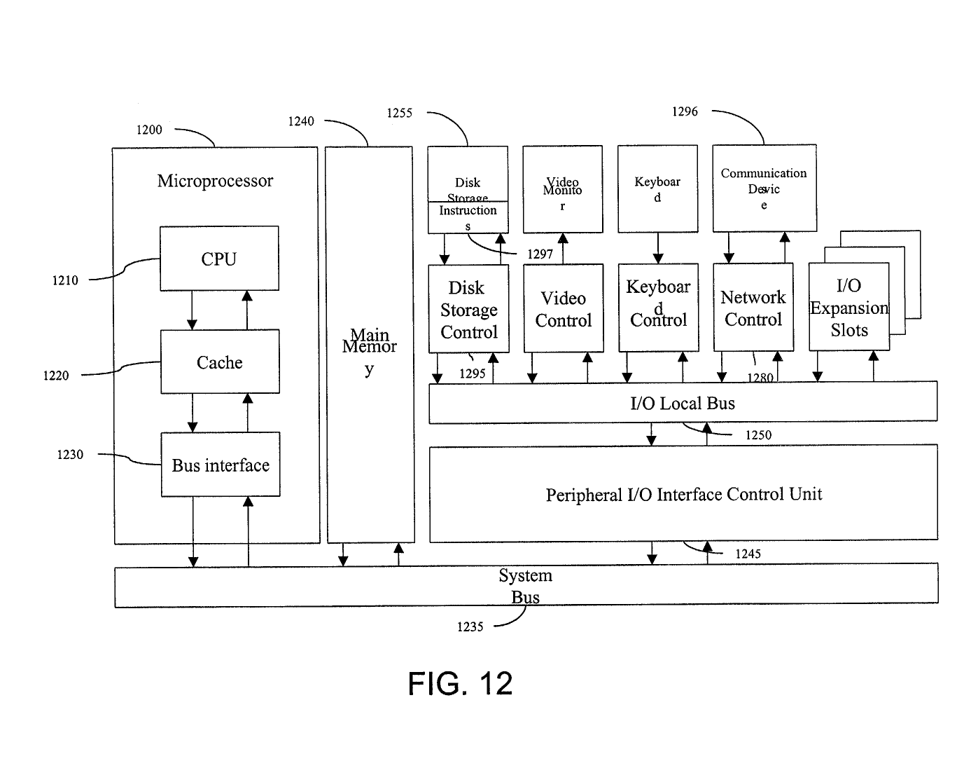

FIG. 12 is a hardware architecture diagram of a general purpose computer suitable for generation of SLA delays or use as a host for a network delay performance system. A microprocessor 1200, including a Central Processing Unit (CPU) 1210, a memory cache 1220, and a bus interface 1230, is operatively coupled via a system bus 1235 to a main memory 1240 and an I/O interface control unit 1245. The I/O interface control unit is operatively coupled via a I/O local bus 1250 to a disk storage controller 1295, and a network controller 1280.

The disk storage controller is operatively coupled to a disk storage device 1225. Computer program instructions 1297, stored in storage device 1225 for generation of SLA delays or implementation of a network delay performance system are stored on the disk storage device. The microprocessor retrieves the computer program instructions and stores them in the main memory. The microprocessor then executes the computer program instructions stored in the main memory to implement the features of a SLA delay generator or a network delay performance system.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

[image]

[image]

[image]

[image]

[image]

[image]

[image]

[image]

[image]

[image]

[image]

[image]

[image]

[image]

What is claimed is:

1. A method for generating a service level agreement delay value for a network, comprising:
receiving a set of network delay samples;
generating a path delay for a path through the network over a specified time period using the set of network delay samples;
generating a confidence interval for the path delay using the specified time period, the set of network delay samples, and a confidence level; and
generating the service level agreement delay value using the path delay and the confidence interval.

2. The method of claim 1, further comprising applying a data sieve to the set of network delay samples.

3. The method of claim 1 wherein the specified time period is a path busy period for the path.

4. The method of claim 3, wherein determining a path busy period further includes:
receiving a time period;
generating a first path delay over the time period at a first time point using the set of network delay samples;
generating a second path delay over the time period at a second time point using the set of network delay samples; and
generating the path busy period by comparing the first path delay to the second path delay.

5. The method of claim 4, wherein generating a path delay at a time point further includes:
determining a set of trunks included in the path;
for each trunk in the set of trunks, performing the following:
generating a trunk delay for a trunk over the time period at the time point using the set of network delay samples; and
adding the trunk delay to the path delay.

6. The method of claim 1, wherein generating a confidence interval for the path delay further includes:
determining a set of trunks included in the path;
generating a set of trunk delay standard deviations from the set of trunks for the specified time period using the set of network delay samples;
generating a path delay standard deviation using the set of trunk delay standard deviations; and
generating the confidence interval using the path delay standard deviation and the confidence level.

7. A method for monitoring a network, comprising:
receiving a set of network delay samples;
generating a path busy period for a path through the network using the set of network delay samples;
generating a path delay for the path using the path busy period and the set of network delay samples;
generating a path delay standard deviation using the path delay, path busy period, and the set of network delay samples;
generating a coefficient of variation for the path delay using the path delay and the path standard deviation; and
generating an alert by comparing the coefficient of variation to a threshold coefficient of variation value.

8. The method of claim 7, further comprising applying a data sieve to the set of network delay samples.

9. The method of claim 7, wherein generating a path busy period further includes:
receiving a time period;
generating a first path delay over the time period at a first time point using the set of network delay samples;
generating a second path delay over the time period at a second time point using the set of network delay samples; and
generating the path busy period by comparing the first path delay to the second path delay.

10. The method of claim 9, wherein generating a path delay at a time point further includes:
determining a set of trunks included in the path;
for each trunk in the set of trunks, performing the following:
generating a trunk delay over the time period at the time point using the set of network delay samples; and
adding the trunk delay to the path delay.

11. The method of claim 7, wherein generating a path delay standard deviation further includes:
determining a set of trunks included in the path;
generating a set of trunk delay standard deviations from the set of trunks for the path busy period using the set of network delay samples; and
generating a path delay standard deviation using the set of trunk delay standard deviations.

12. A method for monitoring a network, comprising:
receiving a set of network delay samples;
generating a path busy period for a path through the network using the set of network delay samples;
generating a confidence interval for the path using the path busy period, the set of network delay samples, and a confidence level;
generating a busy period path delay for the path using the path busy period, the set of network delay samples, and the confidence interval; and
comparing the busy period path delay to a busy period path delay baseline including a plurality of previously generated busy period path delays.

13. The method of claim 12, further comprising applying a data sieve to the set of network delay samples.

14. The method of claim 12, wherein generating a path busy period further includes:
receiving a time period;
generating a first path delay over the time period at a first time point using the set of network delay samples;
generating a second path delay over the time period at a second time point using the set of network delay samples; and
generating the path busy period by comparing the first path delay to the second path delay.

15. The method of claim 14, wherein generating a path delay at a time point further includes:
determining a set of trunks included in the path;
for each trunk in the set of trunks, performing the following:
generating a trunk delay over the time period at the time point using the set of network delay samples; and
adding the trunk delay to the path delay.

16. The method of claim 12, wherein generating a confidence interval for the path further includes:
determining a set of trunks included in the path;
generating a set of trunk delay standard deviations from the set of trunks for the path busy period using the set of network delay samples;
generating a path delay standard deviation using the set of trunk delay standard deviations; and
generating the confidence interval using the path delay standard deviation and the confidence level.

17. A method for monitoring a network, comprising:
receiving a set of network delay samples;
generating a trunk busy period for a trunk in the network using the set of network delay samples;
generating a trunk delay for the trunk using the trunk busy period and the set of network delay samples;
generating a trunk delay standard deviation using the trunk delay, trunk busy period, and the set of network delay samples;
generating a coefficient of variation for the trunk using the trunk delay and the trunk standard deviation; and
generating an alert by comparing the coefficient of variation to a threshold coefficient of variation value.

18. The method of claim 17, further comprising applying a data sieve to the set of network delay samples.

19. The method of claim 17, wherein generating a trunk busy period further includes:
receiving a time period;
generating a first trunk delay over the time period at a first time point using the set of network delay samples;
generating a second trunk delay over the time period at a second time point using the set of network delay samples; and
generating the trunk busy period by comparing the first trunk delay to the second trunk delay.

20. A method for monitoring a network, comprising:
receiving a set of network delay samples;
generating a trunk busy period for a trunk included in the network using the set of network delay samples;
generating a confidence interval for the trunk using the trunk busy period, the set of network delay samples, and a confidence level;
generating a busy period trunk delay for the trunk using the trunk busy period, the set of network delay samples, and the confidence interval; and
comparing the busy period trunk delay to a busy period trunk delay baseline including a plurality of previously generated busy period trunk delays.

21. The method of claim 20, further comprising applying a data sieve to the set of network delay samples.

22. The method of claim 20, wherein generating a trunk busy period further includes:
receiving a time period;
generating a first trunk delay over the time period at a first time point using the set of network delay samples;
generating a second trunk delay over the time period at a second time point using the set of network delay samples; and
generating the trunk busy period by comparing the first trunk delay to the second trunk delay.

23. A method for generating a service level agreement delay value for a network, comprising:
receiving a set of network delay samples;
applying a data sieve to the set of network delay samples;
generating a path busy period for a path through the network by performing the following:
receiving a time period,
generating a first path delay over the time period at a first time point using the set of network delay samples,
generating a second path delay over the time period at a second time point using the set of network delay samples, and
generating the path busy period by comparing the first path delay to the second path delay;
generating a confidence interval for the path delay by performing the following:
determining a set of trunks included in the path;
generating a set of trunk delay standard deviations from the set of trunks for the path busy period using the set of network delay samples,
generating a path delay standard deviation using the set of trunk delay standard deviations, and
generating the confidence interval using the path delay standard deviation and the confidence level; and
generating the service level agreement delay value using the path delay and the confidence interval.

24. The method of claim 23, wherein generating a path delay at a time point further includes:
determining a set of trunks included in the path;
for each trunk in the set of trunks, performing the following:
generating a trunk delay for a trunk over the time period at the time point using the set of network delay samples; and
adding the trunk delay to the path delay.

25. A method for monitoring a network, comprising:
receiving a set of network delay samples;
applying a data sieve to the set of network delay samples;
generating a path busy period for a path through the network by performing the following:
receiving a time period,
generating a first path delay over the time period at a first time point using the set of network delay samples,
generating a second path delay over the time period at a second time point using the set of network delay samples, and
generating the path busy period by comparing the first path delay to the second path delay;
generating a confidence interval for the path delay by performing the following:
determining a set of trunks included in the path;
generating a set of trunk delay standard deviations from the set of trunks for path busy period using the set of network delay samples,
generating a path delay standard deviation using the set of trunk delay standard deviations, and
generating the confidence interval using the path delay standard deviation and the confidence level;
generating a coefficient of variation for the path delay using the path delay and the path standard deviation; and
generating an alert by comparing the coefficient of variation to a threshold coefficient of variation value.

26. The method of claim 25, wherein generating a path delay at a time point further includes:
determining a set of trunks included in the path;
for each trunk in the set of trunks, performing the following:
generating a trunk delay over the time period at the time point using the set of network delay samples; and
adding the trunk delay to the path delay.

27. A data processing apparatus adapted for generating a service level agreement delay value for a network, comprising:
a processor; and
a memory operably coupled to the processor and having program instructions stored therein, the processor being operable to execute the program instructions, the program instructions including:
receiving a set of network delay samples;
generating a path delay for a path through the network over a specified time period using the set of network delay samples;
generating a confidence interval for the path delay using the path delay, the specified time period, the set of network delay samples, and a confidence level; and
generating the service level agreement delay value using the path delay and the confidence interval.

28. The data processing apparatus of claim 27, the program instructions further including applying a data sieve to the set of network delay samples.

29. The data processing apparatus of claim 27 wherein the specified time period is a path busy period for the path.

30. The data processing apparatus of claim 29, wherein the program instructions for determining a path busy period further include:
receiving a time period;
generating a first path delay over the time period at a first time point using the set of network delay samples;
generating a second path delay over the time period at a second time point using the set of network delay samples; and
generating the path busy period by comparing the first path delay to the second path delay.

31. The data processing apparatus of claim 30, wherein the program instructions for generating a path delay at a time point further include:
determining a set of trunks included in the path;
for each trunk in the set of trunks, performing the following:
generating a trunk delay for a trunk over the time period at the time point using the set of network delay samples; and
adding the trunk delay to the path delay.

32. The data processing apparatus of claim 27, wherein generating a confidence interval for the path delay further includes:
determining a set of trunks included in the path;
generating a set of trunk delay standard deviations from the set of trunks for the specified time period using the set of network delay samples;
generating a path delay standard deviation using the set of trunk delay standard deviations; and
generating the confidence interval using the path delay standard deviation and the confidence level.

33. A data processing apparatus adapted for monitoring a network, comprising:
a processor; and
a memory operably coupled to the processor and having program instructions stored therein, the processor being operable to execute the program instructions, the program instructions including:
receiving a set of network delay samples;
generating a path busy period for a path through the network using the set of network delay samples;
generating a path delay for the path using the path busy period and the set of network delay samples;
generating a path delay standard deviation using the path delay, path busy period, and the set of network delay samples;
generating a coefficient of variation for the path delay using the path delay and the path standard deviation; and
generating an alert by comparing the coefficient of variation to a threshold coefficient of variation value.

34. The data processing apparatus of claim 33, the program instructions further including applying a data sieve to the set of network delay samples.

35. The data processing apparatus of claim 33, wherein the program instructions for generating a path busy period further include:
receiving a time period;
generating a first path delay over the time period at a first time point using the set of network delay samples;
generating a second path delay over the time period at a second time point using the set of network delay samples; and
generating the path busy period by comparing the first path delay to the second path delay.

36. The data processing apparatus of claim 35, wherein the program instructions for generating a path delay at a time point further include:
determining a set of trunks included in the path;
for each trunk in the set of trunks, performing the following:
generating a trunk delay over the time period at the time point using the set of network delay samples; and
adding the trunk delay to the path delay.

37. The data processing apparatus of claim 36, wherein the program instructions for generating a path delay standard deviation further include:
determining a set of trunks included in the path;
generating a set of trunk delay standard deviations from the set of trunks for the path busy period using the set of network delay samples; and
generating a path delay standard deviation using the set of trunk delay standard deviations.

38. A data processing apparatus adapted for monitoring a network, comprising:
a processor; and
a memory operably coupled to the processor and having program instructions stored therein, the processor being operable to execute the program instructions, the program instructions including:
receiving a set of network delay samples;
generating a path busy period for a path through the network using the set of network delay samples;
generating a confidence interval for the path using the path busy period, the set of network delay samples, and a confidence level;
generating a busy period path delay for the path using the path busy period, the set of network delay samples, and the confidence interval; and
comparing the busy period path delay to a busy period path delay baseline including a plurality of previously generated busy period path delays.

39. The data processing apparatus of claim 38, the program instructions further including applying a data sieve to the set of network delay samples.

40. The data processing apparatus of claim 38, wherein the program instructions for generating a path busy period further include:
receiving a time period;
generating a first path delay over the time period at a first time point using the set of network delay samples;
generating a second path delay over the time period at a second time point using the set of network delay samples; and
generating the path busy period by comparing the first path delay to the second path delay.

41. The data processing apparatus of claim 40, wherein the program instructions for generating a path delay at a time point further include:
determining a set of trunks included in the path;
for each trunk in the set of trunks, performing the following:
generating a trunk delay over the time period at the time point using the set of network delay samples; and
adding the trunk delay to the path delay.

42. The data processing apparatus of claim 38, wherein the program instructions for generating a confidence interval for the path further include:
determining a set of trunks included in the path;
generating a set of trunk delay standard deviations from the set of trunks for the path busy period using the set of network delay samples;
generating a path delay standard deviation using the set of trunk delay standard deviations; and
generating the confidence interval using the path delay standard deviation and the confidence level.

43. A data processing apparatus adapted for monitoring a network, comprising:
a processor; and
a memory operably coupled to the processor and having program instructions stored therein, the processor being operable to execute the program instructions, the program instructions including:
receiving a set of network delay samples;
generating a trunk busy period for a trunk in the network using the set of network delay samples;
generating a trunk delay for the trunk using the trunk busy period and the set of network delay samples;
generating a trunk delay standard deviation using the trunk delay, trunk busy period, and the set of network delay samples;
generating a coefficient of variation for the trunk using the trunk delay and the trunk standard deviation; and
generating an alert by comparing the coefficient of variation to a threshold coefficient of variation value.

44. The data processing apparatus of claim 43, the program instructions further including applying a data sieve to the set of network delay samples.

45. The data processing apparatus of claim 43, wherein the program instructions for generating a trunk busy period further include:
receiving a time period;
generating a first trunk delay over the time period at a first time point using the set of network delay samples;
generating a second trunk delay over the time period at a second time point using the set of network delay samples; and
generating the trunk busy period by comparing the first trunk delay to the second trunk delay.

46. A data processing apparatus adapted for monitoring a network, comprising:
a processor; and
a memory operably coupled to the processor and having program instructions stored therein, the processor being operable to execute the program instructions, the program instructions including:
receiving a set of network delay samples;
generating a trunk busy period for a trunk included in the network using the set of network delay samples;
generating a confidence interval for the trunk using the trunk busy period, the set of network delay samples, and a confidence level;
generating a busy period trunk delay for the trunk using the trunk busy period, the set of network delay samples, and the confidence interval; and
comparing the busy period trunk delay to a busy period trunk delay baseline including a plurality of previously generated busy period trunk delays.

47. The data processing apparatus of claim 45, wherein the program instructions for generating a trunk busy period further includes:
receiving a time period;
generating a first trunk delay over the time period at a first time point using the set of network delay samples;
generating a second trunk delay over the time period at a second time point using the set of network delay samples; and
generating the trunk busy period by comparing the first trunk delay to the second trunk delay.

48. A data processing apparatus adapted for generating a service level agreement delay value, comprising:
a processor; and
a memory operably coupled to the processor and having program instructions stored therein, the processor being operable to execute the program instructions, the program instructions including:
receiving a set of network delay samples;
applying a data sieve to the set of network delay samples;
generating a path busy period for a path through the network by performing the following:
receiving a time period,
generating a first path delay over the time period at a first time point using the set of network delay samples,
generating a second path delay over the time period at a second time point using the set of network delay samples, and
generating the path busy period by comparing the first path delay to the second path delay;
generating a confidence interval for the path delay by performing the following:
determining a set of trunks included in the path;
generating a set of trunk delay standard deviations from the set of trunks for the path busy period using the set of network delay samples,
generating a path delay standard deviation using the set of trunk delay standard deviations, and
generating the confidence interval using the path delay standard deviation and the confidence level; and
generating the service level agreement delay value using the path delay and the confidence interval.

49. The data processing apparatus of claim 48, wherein the program instructions for generating a path delay at a time point further include:
determining a set of trunks included in the path;
for each trunk in the set of trunks, performing the following:
generating a trunk delay for a trunk over the time period at the time point using the set of network delay samples; and
adding the trunk delay to the path delay.

50. A data processing apparatus adapted for monitoring a network, comprising:
a processor; and
a memory operably coupled to the processor and having program instructions stored therein, the processor being operable to execute the program instructions, the program instructions including:
receiving a set of network delay samples;
applying a data sieve to the set of network delay samples;
generating a path busy period for a path through the network by performing the following:
receiving a time period,
generating a first path delay over the time period at a first time point using the set of network delay samples,
generating a second path delay over the time period at a second time point using the set of network delay samples, and
generating the path busy period by comparing the first path delay to the second path delay;
generating a confidence interval for the path delay by performing the following:
determining a set of trunks included in the path,
generating a set of trunk delay standard deviations from the set of trunks for path busy period using the set of network delay samples,
generating a path delay standard deviation using the set of trunk delay standard deviations, and
generating the confidence interval using the path delay standard deviation and the confidence level;
generating a coefficient of variation for the path delay using the path delay and the path standard deviation; and
generating an alert by comparing the coefficient of variation to a threshold coefficient of variation value.

51. The data processing apparatus of claim 50, wherein the program instructions for generating a path delay at a time point further include:
determining a set of trunks included in the path;
for each trunk in the set of trunks, performing the following:
generating a trunk delay over the time period at the time point using the set of network delay samples; and
adding the trunk delay to the path delay.

52. A computer readable media embodying program instructions for execution by a data processing apparatus, the program instructions adapting a data processing apparatus for generating a service level agreement delay value, the program instructions comprising:
receiving a set of network delay samples;
applying a data sieve to the set of network delay samples;
generating a path busy period for a path through the network by performing the following:
receiving a time period,
generating a first path delay over the time period at a first time point using the set of network delay samples,
generating a second path delay over the time period at a second time point using the set of network delay samples, and
generating the path busy period by comparing the first path delay to the second path delay;
generating a confidence interval for the path delay by performing the following:
determining a set of trunks included in the path;
generating a set of trunk delay standard deviations from the set of trunks for the path busy period using the set of network delay samples,
generating a path delay standard deviation using the set of trunk delay standard deviations, and
generating the confidence interval using the path delay standard deviation and the confidence level; and
generating the service level agreement delay value using the path delay and the confidence interval.

53. The computer readable media of claim 52, wherein the program instructions for generating a path delay at a time point further include:
determining a set of trunks included in the path;
for each trunk in the set of trunks, performing the following:
generating a trunk delay for a trunk over the time period at the time point using the set of network delay samples; and
adding the trunk delay to the path delay.

54. A computer readable media embodying program instructions for execution by a data processing apparatus, the program instructions adapting a data processing apparatus for monitoring a network, the program instructions comprising:
receiving a set of network delay samples;
applying a data sieve to the set of network delay samples;
generating a path busy period for a path through the network by performing the following:
receiving a time period,
generating a first path delay over the time period at a first time point using the set of network delay samples,
generating a second path delay over the time period at a second time point using the set of network delay samples, and
generating the path busy period by comparing the first path delay to the second path delay;
generating a confidence interval for the path delay by performing the following:
determining a set of trunks included in the path,
generating a set of trunk delay standard deviations from the set of trunks for path busy period using the set of network delay samples,
generating a path delay standard deviation using the set of trunk delay standard deviations, and
generating the confidence interval using the path delay standard deviation and the confidence level;
generating a coefficient of variation for the path delay using the path delay and the path standard deviation; and
generating an alert by comparing the coefficient of variation to a threshold coefficient of variation value.

55. The computer readable media of claim 54, wherein the program instructions for generating a path delay at a time point further include:
determining a set of trunks included in the path;
for each trunk in the set of trunks, performing the following:
generating a trunk delay over the time period at the time point using the set of network delay samples; and
adding the trunk delay to the path delay.
